(19) United States
(12) Patent Application Publication
(10) Pub. No.: US 2009/0320020 A1
(43) Pub. Date: Dec. 24, 2009

(54) Method and System for Optimising A Virtualisation Environment

(75) Inventors: Antonio Perrone, Roma (IT); Stefano Sidoti, Rome (IT)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/490,686

(22) Filed: Jun. 24, 2009

(30) Foreign Application Priority Data
Jun. 24, 2008 (EP) 08158819.6

(51) Int. Cl. G06F 9/455

(52) U.S. Cl. 718/1

(57) ABSTRACT

A mechanism for advising users on how to optimize their virtualisation infrastructure to minimise their software costs. There are two aspects to solution. The first aspect considers the distribution of software in the virtualised environment. The second aspect determines the proper licence types (e.g., sub-capacity or full capacity) for the virtualised environment, based on the usage of the software products therein.

### TECHNICAL FIELD

The present invention relates to a method, system and computer program for optimising a virtualisation environment.

### BACKGROUND

A modern software service typically comprises a set of software components which have complex inter-dependencies there between. In order for the whole system to function correctly, each of the software components must be configured correctly with respect to the others. On-demand computing is an enterprise-level computing model that allocates computing resources to an organisation and its individual users on an as-needed basis. This enables the enterprise to efficiently meet fluctuating computing demands. One of the main tools used in implementing an on-demand computing model is server virtualisation.

A virtual environment typically comprises a large number of virtual machines (or logical partitions) residing on a small number of real servers. Thus, a software service in a virtualisation environment is often distributed over the plurality of virtual machines. Traditional methods of deploying a software service involve installing and configuring its components one by one. However, in a distributed virtualisation environment this process becomes very time-consuming and labour-intensive. Thus, software configuration in a virtualisation environment focuses on achieving optimal (or near optimal) functioning thereof and does not usually consider the costs of implementing the software.

US Patent Application No. US2007067433 describes a system for controlling virtual machines in a system management application. The system comprises an enabler in a physical host machine implementing guest machines. The enabler gathers information relating to the hardware configuration of the host machine and passes this information to a licensing agent of the guest machine. The licensing agent directly gathers other information (e.g., relating to the software products that are usable on the guest machine). The information is then transmitted to the licensing agent through a run-time server for the correct management of the guest machine.

From this, it can be seen that US2007067433 focuses on metering software use rather than optimising licences therefrom. Furthermore, the system of US2007067433 involves storing and processing a considerable amount of data (in the form of software usage statistics) and would become rapidly overloaded with data in a large scale virtualisation environment. Thus, the system described in US2007067433 has limited use in large scale virtualisation environments. Finally, the software that is monitored in US2007067433 must be explicitly enabled to be monitored in this fashion. This requirement would add a further administrative burden to the system administrator of a virtualisation environment.

U.S. Pat. No. 7,313,512 describes a method of licensing software of one or more guest computer systems. The method employs a licence key-server in a host computer system to monitor the initiation of un-licensed software in a guest computer system. More particularly, the licence key server determines whether an additional licence is available for each unlicensed software application and, if so, grants a licence therefore and decrements the count of available licences. However, if a licence is not available a licence is not granted and the unlicensed software application in the guest computer system is disabled.

US Patent Application No. US20060004667 describes a system for collecting licence revenue for operating systems or applications software that reside in a virtualised computer system. More particularly, US20060004667 ensures licence compliance on a virtual machine through the use of a licence card virtual device. However, US20060004667 does not discuss methods of optimising software installation and distribution; and choice of most appropriate licences for software products.

### SUMMARY OF THE INVENTION

According to the invention there is provided a method, product and system for reducing a cost of a one or more software applications installed in a virtualised computing environment comprising a one or more virtual machines. A a property is identified of the virtual machines consumable by the virtual machines. The virtual machines are polled to determine the amount of the property The virtual machines are polled to determine the usage of the one or more installed software. A first value is the total amount of the property in substantially all the virtual machines. A second value is the amount of the property in the virtual machines in which a one or more of the software applications is installed. The determined usage is compressed of the one or more software applications. Polling and determining the usage of the property is performed for a predetermined period of time. A third value is calculated from the sum of the compressed usage determined over the period of time. A first and second usage metric is calculated from the first, second and third values;. Possible changes to the distribution of the installed software applications to improve the first usage metric are presented to the user. The user is presented installation options for a one or more of the software applications to a one or more of the virtual machines in accordance with the advised changes. Possible changes to licence types for the installed software applications to improve the second usage metric are presented to the user. The user is presented options to change a licence type for a one or more of the software applications in accordance with the advised changes.

### BRIEF DESCRIPTION OF THE DRAWINGS

An embodiment of the invention is herein described, by way of example only, with reference to the accompanying figures in which:

FIG. 1 is a flow-chart of method of the preferred embodiment; and

FIG. 2 is a block diagram of a computer system adapted to perform the method depicted in FIG. 1.

### DETAILED DESCRIPTION OF THE INVENTION

The preferred embodiment provides a mechanism for advising users on how to leverage their virtualisation infrastructure to minimise their software costs. There are two aspects to the solution provided by the preferred embodiment. The first aspect considers the virtualised environment itself and the distribution of software products therein. For example, in a virtualised environment, it is possible to determine the best operating system on which to have a software product installed, based on the actual usage of the product. The second aspect relates to determining the most appropriate licence types for the software products, based on the usage of those products.

For simplicity, and in recognition of their expression as logical partitions, the virtual machines in a virtualisation environment will be known henceforth as partitions. In principle, a software product can be installed in each partition of a virtualised environment. Furthermore, the software product can also, in principle, be used/run within each partition. In support of this activity, a license can be bought for the software product by a Contract Manager. Licenses can be either Sub-Capacity or Full-Capacity, depending on the extent of their usage of a particular resource (e.g. processors, memory, disk space, etc.) of the partition on which it is installed. For example, a “Sub-Capacity per processor” license bought for product p1, allows an Administrator to run p1 so that it consumes a certain amount of processor capacity of the individual partitions on which p1 is installed. The consumable amount of capacity is specified in the Terms and Conditions of the license. Similarly, a “Sub Capacity per processor” licence for product p1, of allowed consumable property 4 GHz means that p1 is allowed to run in one partition which has been assigned a processor of 4 GHz, two processors of 2 GHz, or similar combinations. More generally, p1 could be run concurrently in n partitions if the sum of the GHz assigned to the n partitions is less or equal to 4 Ghz. Naturally, the cost of a licence will depend on whether it is a sub-capacity or full-capacity. However, sub-capacity licences have an additional implementation cost (e.g., because of the need for the deployment of a licence management tool to monitor the actual charge accounted to the customer).

Take, for example, software products that are licensed on a processor base and installed in a virtualised environment comprising hosting nodes and operating system images. The preferred embodiment deals with the following issues:
determining which products are currently licensed on the processor base;
determining the operating system images on which the products are installed;
monitoring the use of all the installed software on each operating system image and collecting the information to enable the distribution of installed and/or used software within the virtualised environment to be displayed and analysed;
providing feedback on the merits of the current distribution of the installed software products;
advising on the benefits of choosing a sub-capacity licence as opposed to a full-capacity licence for the software products;
providing additional information (e.g. details about the machines and/or partitions on which each product is installed and/or running and virtualisation information);
allowing the addition and/or removal of machines and/or partitions from the calculation;
enabling the usage analysis to be limited according to geographical and/or logical topology; and
computing and showing any capacity-based type metric.

In support of the above, the preferred embodiment comprises client-side and server-side operations. In use, a client that is active on a single operating system image is capable of retrieving and sending to a server, information about the capacity assigned to it, the virtualisation layers that it leverages; and the software installed thereon.

The preferred embodiment calculates and correlates for each product, the following indicators:
a total sub-capacity metric of all the installed instances of the product (Installed Product Capacity or IPC);
a total sub-capacity metric of the used instances of the product (Used Product Capacity or UPC); and
a total full-capacity metric of the installed instances of the product (Full Capacity or FC).

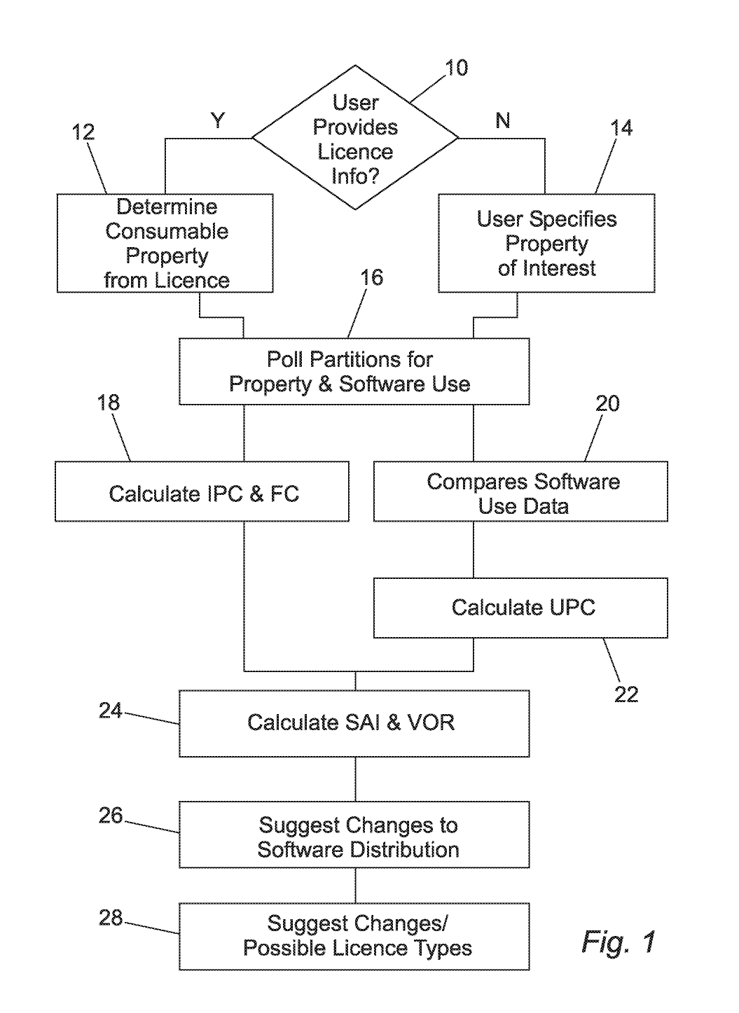

More specifically, and referring to FIG. 1, in a first step, the preferred embodiment provides 10 a manager with the option of manually associating each installed product in a virtualisation environment with the licence already bought for the product. The preferred embodiment also prompts the manager to indicate whether the licence is full-capacity or sub-capacity. On receipt of this information, the preferred embodiment examines the licence for a given software product to determine 12 the specified property (e.g., CPU, memory, or disk space etc.) which may be consumed by the software product. If the manager has not provided information regarding the licences bought for the virtualisation environment, the manager is allowed to specify 14 a particular property of the partitions to be used for assessing the current software distribution in the virtualisation environment.

Once the relevant property has been identified, the preferred embodiment uses agents (one per partition) at the client side the interrogate 16 the partitions and determine therefrom the value of the property. From this, the preferred embodiment calculates 18 the FC as the total amount of the relevant property in each partition in the virtualised environment. Similarly, the preferred embodiment calculates 18 the IPC as the total amount of the relevant property of the partitions on which the software product is installed. In particular, suppose, for example, that product p1 is installed on partition P1 of a double partitioned machine comprising 2 processors. Further assume that 0.5 processors are assigned to partition P1. In this case, FC=2 and the IPC for p1=0.5.

The IPC and FC values are recalculated at least every day, on a regular basis. In particular, these variables are calculated every day at the server-side by leveraging the data retrieved by the agents that periodically (i.e. more than once a day) poll the partitions to determine the relevant property (e.g., how much CPU is assigned to the partition and the whole machine). This information is aggregated at the server-side to provide a complete representation of how the IPC and FC variables change over time. However, in practice, the IPC, and more particularly, the FC variable, do not change very often.

Whilst polling 16 the partitions to determine the value of the relevant property, the agents also determine which software products are installed on the partitions and the extent to which those software products are run in the partitions. This effectively provides a calendar representation of the daily usage of a software product in the virtualisation environment. The preferred embodiment stores 16 this information and reduces 20 it to a single bit for each product and day, wherein a value of 1 indicates that the product was found to be active on the relevant day and a value of 0 indicates the product was inactive. The preferred embodiment calculates 22 the UPC from the sum of the single bits over a pre-defined monitoring period. The following inequality will be valid for each installed product each day UPC≦IPC≦1.

The server uses this information to calculate 24 a virtualisation optimisation rate (VOR) and sub-capacity advantage indicator (SAI) for each product. More particularly, defining n=the number of days in the monitoring period, UPC(i) and IPC(i) as the UPC and IPC values on a given day i (i=1 to n), UPĈ can be defined as

$$U P {C}^{\hat{}} = 1 \text{/} n {\sum }_{i = 1}^{n} ( U P {C}_{i} \text{/} {FC}_{i} ) .$$

Similarly, IPĈ can be defined as

$$I P {C}^{\hat{}} = 1 / n {\sum }_{i = 1}^{n} ( I P {C}_{i} \text{/} {FC}_{i} ) .$$

This results in the following inequality expression UPĈ≦IPC≦1. In general, the VOR for a product will be higher the closer UPĈ is to IPĈ. In other words, the customer is efficiently using the virtualised environment if they are fully using the products that have been installed in the operating system images. For this reason, VOR can be defined as VOR=UPĈ/IPĈ. Thus, the closer a VOR value is to 1, the greater the optimisation of the virtualisation environment.

In general, the SAI for product is inversely related to UPĈ. In other words, the more pervasive the use of a software product in a virtualisation environment, the more beneficial it is to purchase a full capacity licence for it. Thus, the SAI can be defined as SAI=1−UPĈ. Thus, the closer an SAI value is to 1, the more a Sub-Capacity license is appropriate for the software product.

Based on these calculations, the preferred embodiment advises a manager of a virtualisation environment on how to:
change 26 (if necessary) the distribution of software installed in the virtualisation environment, to achieve an optimal VOR; and/or
select 28 the best type of licence distribution for the environment (based on the SAI value therefore).

(a) Recommendations about Changes in Software Distribution

In this process, the preferred embodiment displays a list of options for achieving an optimal VOR value (e.g., removing a rarely used software product from a particular operating system image). Through the above polling mechanism, the preferred embodiment will automatically detect if the manager uninstalls the product and update the VOR accordingly. The preferred embodiment will similarly detect if a new software product is installed to a partition and update the VOR accordingly.

The preferred embodiment also provides a manager with the option of defining a VOR threshold beyond which the preferred embodiment provides recommendations to the manager. In particular, in a pre-configuration step, the preferred embodiment allows a manager to establish a VOR threshold, below which the preferred embodiment will provide suggestions on how to adjust software distribution and/or licences therefore, to reduce the software cost of the virtualisation environment. If as a result of a change in the usage of a particular software product on partition p1, a VOR value changes from 0.4 to 0.8 (wherein the threshold was set at 0.75) the preferred embodiment removes its recommendation for alterations to the virtualisation environment.

(b) Recommendations about Changes to Licence Arrangements

As discussed above, the preferred embodiment provides a manager with an option to provide information about the licences bought for the software products installed in the virtualisation environment. In the event the manager does not provide any information about the licenses currently bought for the software products, the preferred embodiment provides recommendations (through the SAI indicator) on an appropriate license type to choose for the software product. In other words, as mentioned above, the closer an SAI value is to 1, the more a Sub-Capacity license is appropriate for the software product.

In the event the manager has provided the preferred embodiment with information concerning the licences bought for the software products in the virtualisation environment, the preferred embodiment compares the SAI value of a software product in the virtualisation environment with the licence type information for the product provided by the manager. In the event, the two licence types do not match (e.g., if the preferred embodiment determines an SAI of 0.9 for product p1 bought with a full-capacity license) the preferred embodiment advises the manager to change the license for the product.

Since, as mentioned before, licenses are managed externally to the preferred embodiment, in the event the preferred embodiment suggests changing the software licences to or from sub-capacity or full-capacity, the administrator must manually effect the change in the licences and update the relevant information in the preferred embodiment accordingly.

### EXAMPLE 1

Take a machine with FC=10 and five partitions (each of which consumes an FC of 2). Further assume that the preferred embodiment is configured to monitor the machine for a period of ten days. Assume that a product p1 has been installed on partitions P1, P2 and P3. Further assume that product p2 has been installed on partitions P4 and P5. Finally, suppose that product p1 has been found to be active on partitions P1, P2 and P3 for one day, eight days and six days respectively. Further, assume that product p2 has been found active on partitions P4 and P5 for all of the ten days.

In this case, the preferred embodiment calculates VOR=0.5 for p1 and VOR=1 for product p2. Similarly, the preferred embodiment calculates SAI=0.7 for p1 and SAI=0.6 for product p2. In other words, product p2 is much more efficiently installed in the virtualised environment than product p1. Furthermore, a sub-capacity licence is good for product p1 but a little less good for product p2. The preferred embodiment if asked by the user for suggestions on how to improve the product p1 installation distribution would advise the removal of product p1 from partition P1 and installation of product p1 on partition P3, thereby achieving a VOR value of 0.75, namely an increase of 50% on the previous VOR value.

### EXAMPLE 2

Consider the installation and frequent use of a software product on the machine of the previous example. Assume that the same operating system is installed on each image. In this case, since the SAI of the both partitions equals zero, the customer will find it more beneficial to purchase a full capacity licence for the software product rather than a sub-capacity software licence. Analagous information is provided by the preferred embodiment for products with a low SAI value (in accordance with the thresholds defined by the user).

### Hardware Architecture for Method of the Preferred Embodiment

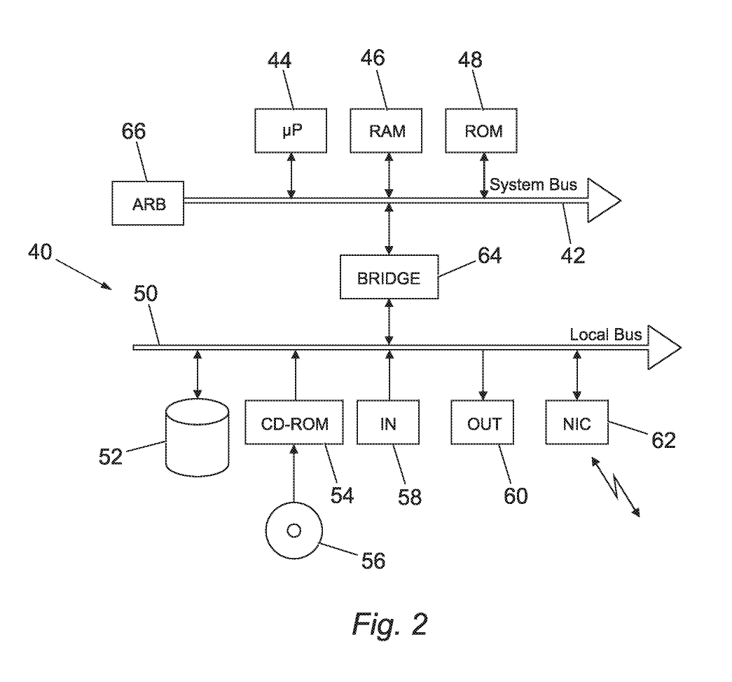

Referring to FIG. 2, a generic computer system 40 adapted to support the preferred embodiments is formed by several units that are connected in parallel to a system bus 42. In detail, one or more microprocessors (XP) 44 control operation of the computer 40; a RAM 46 is directly used as a working memory by the microprocessors 44, and a ROM 48 stores basic code for a bootstrap of the computer 40. Peripheral units are clustered around a local bus 50 (by means of respective interfaces). Particularly, a mass memory consists of a hard-disk 52 and a drive 54 for reading CD-ROMs 56. Moreover, the computer 40 includes input devices 58 (for example, a keyboard and a mouse), and output devices 60 (for example, a monitor and a printer). A Network Interface Card (NIC) 62 is used to connect the computer 40 to the network. A bridge unit 64 interfaces the system bus 42 with the local bus 50. Each microprocessor 44 and the bridge unit 64 can operate as master agents requesting an access to the system bus 42 for transmitting information. An arbiter 66 manages the granting of the access with mutual exclusion to the system bus 42.

Similar considerations apply if the system has a different topology, or it is based on other networks. Alternatively, the computers have a different structure, including equivalent units, or consist of other data processing entities (such as PDAs, mobile phones and the like).

The preferred embodiment provides a VOR indicator to advise the manager of a virtualisation environment about an optimal distribution and installation of software across the virtualised environment which most closely reflect the usage of software in that environment. Similarly, the preferred embodiment provides an SAI indicator to advise contract managers of virtualisation environments about the most appropriate types of software licences for the environment in view of the software usage.

Similarly, the preferred embodiment stores, computes and aggregates small amounts of data compared to conventional software monitoring products. Thus, the method of preferred embodiment is eminently scalable and capable of addressing a broad range of products (i.e. all the software products in a software catalogue) and not just the software products that have been previously enabled within a virtualisation environment. Furthermore, the suggestions provided by the preferred embodiment are capable of being used within a provisioning system to re-distribute software products within the virtualisation environment.

In U.S. Pat. No. 7,313,512, licence information is managed by balancing unconsumed software licences within a virtual machine. In contrast, the preferred embodiment manages the distribution of licences and software installations amongst multiple virtual machines. In particular, the preferred embodiment provides insight into which operating system image it is better to have a product installed on, based on the actual usage of that product. However, U.S. Pat. No. 7,313,512 does not provide any such guidance. Furthermore, the preferred embodiment advises on optimal licence types for a given virtualisation environment (i.e. whether a licence ought to be sub-capacity or full-capacity) whereas U.S. Pat. No. 7,313,512 does not provide any such guidance. Finally, the preferred embodiment is a client/server system that leverages two indicators that are evaluated at the server-side to advise an administrator of software distribution over an entire virtualised environment and best licence types for each product at the client-side. However, U.S. Pat. No. 7,313,512 does not deal with any of these issues.

Alterations and modifications may be made to the above without departing from the scope of the invention.

1. A method of reducing cost of a one or more software applications installed in a virtualised computing environment comprising a one or more virtual machines, the method comprising:
identifying a property of the virtual machines consumable by the virtual machines;
polling the virtual machines to determine the amount of the property therein;
polling the virtual machines to determine the usage of the one or more software applications installed therein;
calculating a first value being the total amount of the property in substantially all the virtual machines;
calculating a second value being the amount of the property in the virtual machines in which a one or more of the software applications is installed;
compressing the determined usage of the one or more software applications;
performing the above steps for a predetermined period of time;
calculating a third value from the sum of the compressed usage determined over the period of time;
calculating a first and second usage metric from the first, second and third values;
presenting advised changes to a distribution of the installed software applications to improve the first usage metric;
responsive to user input, making installation changes to a one or more of the software applications to a one or more of the virtual machines in accordance with the advised changes;
presenting advised licence types for the installed software applications to improve the second usage metric; and
responsive to user input, making licence type changes for a one or more of the software applications in accordance with the advised licence types.

2. The method as claimed in claim 1, wherein identifying a property of the virtual machines consumable by the virtual machines comprises responsive to user input specifying a property of interest.

3. The method as claimed in claim 1, further comprising using user input to provide information regarding a one or more licences already bought for the one or more software applications installed in the virtualised computing environment; identifying a property of the virtual machines consumable by the virtual machines comprises identifying the consumable property specified in the licence for a given one or more of the software applications.

4. The method as claimed in claim 3, wherein responsive to user input, making licence type changes for a one or more of the software applications, comprises using user input to amend the information provided regarding a one or more licences already bought for the one or more software applications.

5. The method as claimed in claim 1, compressing the determined usage of the one or more software applications comprises:
encoding the determined usage with a value approximately equal to one in the event the determined usage indicates that the corresponding software product was active at a given polling time; and
encoding the determined usage with a value approximately equal to zero in the event the determined usage indicates that the corresponding software product was inactive at the polling time.

6. The method as claimed in claim 1 calculating a first and second usage metric from the first, second and third values comprises:
calculating a fourth value from the average of the third value divided by the first value over the predetermined period of time;
calculating a fifth value from the average of the second value divided by the first value over the predetermined period of time;
calculating the first usage metric from the fourth value divided by the fifth value; and
calculating the second usage metric as a value substantially equal to one, minus the third value.

7. The method as claimed in claim 1 wherein the method further comprises providing a threshold value for the first and second usage metrics beyond which the method does not present advised changes to installed application distribution or licence type.

8. A system for reducing cost of a one or more software applications installed in a virtualised computing environment, comprising:
a processor;
a computer memory for storing instructions which when executed by the processor perform the method of:
identifying a property of the virtual machines consumable by the virtual machines;
polling the virtual machines to determine the amount of the property therein;
polling the virtual machines to determine the usage of the one or more
software applications installed therein;
calculating a first value being the total amount of the property in substantially all the virtual machines;
calculating a second value being the amount of the property in the virtual machines in which a one or more of the software applications is installed;
compressing the determined usage of the one or more software applications;
performing the above steps for a predetermined period of time;
calculating a third value from the sum of the compressed usage determined over the period of time;
calculating a first and second usage metric from the first, second and third values;
presenting advised changes to a distribution of the installed software applications to improve the first usage metric;
responsive to user input, making installation changes to a one or more of the software applications to a one or more of the virtual machines in accordance with the advised changes;
presenting advised licence types for the installed software applications to improve the second usage metric; and
responsive to user input, making licence type changes for a one or more of the software applications in accordance with the advised licence types.

9. A computer program product stored in a medium readable by a computer machine, the computer program product tangibly embodying readable program means by causing the computer to perform the method comprising:
identifying a property of the virtual machines consumable by the virtual machines;
polling the virtual machines to determine the amount of the property therein;
polling the virtual machines to determine the usage of the one or more software applications installed therein;
calculating a first value being the total amount of the property in substantially all the virtual machines;
calculating a second value being the amount of the property in the virtual machines in which a one or more of the software applications is installed;
compressing the determined usage of the one or more software applications;
performing the above steps for a predetermined period of time;
calculating a third value from the sum of the compressed usage determined over the period of time;
calculating a first and second usage metric from the first, second and third values;
presenting advised changes to a distribution of the installed software applications to improve the first usage metric;
responsive to user input, making installation changes to a one or more of the software applications to a one or more of the virtual machines in accordance with the advised changes;
presenting advised licence types for the installed software applications to improve the second usage metric; and
responsive to user input, making licence type changes for a one or more of the software applications in accordance with the advised licence types.
